(19) United States
(12) Patent Application Publication
(10) Pub. No.: US 2026/0328663 A1
(43) Pub. Date: Oct. 22, 2026

(54) TEST PLATFORM AND METHOD FOR ANCHORAGE SUPPORT SYSTEM IN DEEP ROCK MASS ENGINEERING

(71) Applicants: Shandong University of Science and Technology, Qingdao (CN); QINGDAO QIANKUNXING INTELLIGENT TECHNOLOGY CO., LTD., Qingdao (CN)

(72) Inventors: Yujing JIANG, Qingdao (CN); Xinpeng LI, Qingdao (CN); Hengjie LUAN, Qingdao (CN); Sunhao ZHANG, Qingdao (CN); Jianrong LIU, Qingdao (CN); Lianjun CHEN, Qingdao (CN); Qingwang HAO, Qingdao (CN); Xiangxu MENG, Qingdao (CN); Bao SHI, Qingdao (CN); Chuanyang JIA, Qingdao (CN); Zhao SUN, Qingdao (CN); Qinglin SHAN, Qingdao (CN)

(21) Appl. No.: 19/468,209

(22) Filed: Feb. 3, 2026

(30) Foreign Application Priority Data
Feb. 5, 2025 (CN) 202510127759.4

(51) Int. Cl. G01N 3/02; G01N 3/24

(52) U.S. Cl. CPC G01N 3/02; G01N 3/24

(57) ABSTRACT

The present invention discloses a test platform and method for an anchorage support system in deep rock mass engineering. The platform includes a loading host, guide rails, an anchored body confining pressure pull-out unit, an anchored body double-shear unit, a surface protection structure performance testing unit, a moving unit, a hydraulic servo system, a control system, and an operating system. The test platform and method for an anchorage support system in deep rock mass engineering can conveniently perform accurate tests through a single test platform, and can realistically simulate the stress conditions of the anchorage support system, test the bearing capacity of the anchorage support system, and reveal the corresponding action mechanisms of the anchorage support system, so that relevant test results can provide key theoretical and technical support for the safe construction of deep rock mass engineering and the efficient and safe exploitation of deep underground resources.

### CROSS-REFERENCE TO RELATED APPLICATIONS

This application claims priority to Chinese Application No. 202510127759.4, filed on Feb.5, 2025, entitled “test platform and method for anchorage support system in deep rock mass engineering”. These contents are hereby incorporated by reference.

### TECHNICAL FIELD

The present invention belongs to the technical field of testing an anchorage support system in deep rock mass engineering, and specifically relates to a test platform and method for an anchorage support system in deep rock mass engineering.

### BACKGROUND

In the construction of deep rock mass engineering (e.g., deep roadways), surrounding rock is prone to severe deformation and even impact disasters such as rockburst. Anchorage support systems such as anchor bolts/cables are the most direct and effective means for supporting surrounding rock. Currently, the design of anchorage support systems for most deep rock mass engineering projects still relies on experience, involving continuous revision of support parameters or support system design through measures, or even attempting to achieve disaster prevention and mitigation by continuously increasing support intensity. However, the results are often counterproductive and ineffective. The unclear support mechanism and lack of design theory for anchorage support systems result in severe arbitrariness, inefficiency, and uncertainty in current support for deep rock mass engineering. The lag in disaster prevention technology and support design theory behind the current state of deep underground engineering activities poses significant challenges to the construction of deep rock mass engineering. Therefore, the support mechanism and design theory of anchorage support systems are major scientific problems that urgently need to be solved. There is an urgent need to conduct mechanical tests on anchorage support systems, realistically simulate the stress conditions of anchorage support systems, test the bearing capacity of anchorage support systems, and reveal the corresponding action mechanisms of anchorage support systems, so that relevant test results can provide key theoretical and technical support for the safe construction of deep rock mass engineering and the efficient and safe exploitation of deep underground resources.

### SUMMARY

An objective of the present invention is to provide a test platform and method for an anchorage support system in deep rock mass engineering, which can realistically simulate the stress conditions of the anchorage support system and conduct accurate mechanical tests on the anchorage support system.

To achieve the above objective, the technical solution adopted by the present invention is as follows:
provided is a test platform for an anchorage support system in deep rock mass engineering, comprising:
   a loading host;
   guide rails which are arranged in several groups, pass through the loading host and extend toward the periphery of the loading host;
   an anchored body confining pressure pull-out unit which is arranged on one of the groups of guide rails and can move along the guide rails to the position of the loading host, and on which the loading host acts to perform a confining pressure pull-out test;
   an anchored body double-shear unit which is arranged on one of the groups of guide rails and can move along the guide rails to the position of the loading host, and on which the loading host acts to perform a double shear test; and
   a surface protection structure performance testing unit which is arranged on one of the groups of guide rails and can move along the guide rails to the position of the loading host, and on which the loading host acts to perform an anchor mesh pull-out test.

Further, the loading host comprises a base, columns, a reaction frame, a hollow loading hydraulic cylinder, and a loading head, wherein the guide rails pass through an upper end surface of the base, the base and the reaction frame are connected by a plurality of columns, the hollow loading hydraulic cylinder is arranged on the reaction frame; the hollow loading hydraulic cylinder is arranged along a vertical direction, and the loading head is arranged at a telescopic end of the hollow loading hydraulic cylinder; and the loading head selectively acts on the anchored body confining pressure pull-out unit, the anchored body double-shear unit, and the surface protection structure performance testing unit.

Further, the loading host further comprises a displacement sensor and a pressure sensor; wherein a sensing end of the displacement sensor is arranged inside the hollow loading hydraulic cylinder to monitor the hydraulic oil pressure inside the hollow loading hydraulic cylinder; the pressure sensor is arranged between the telescopic end of the hollow loading hydraulic cylinder and the loading head to monitor the pressure applied by the loading head;

Further, the loading head comprises an upper loading seat, a lower loading seat, and a loading frame;

wherein the upper loading seat is connected to the telescopic end of the hollow loading hydraulic cylinder, the lower loading seat is located below the upper loading seat, and the upper loading seat and the lower loading seat are connected by the loading frame.

Further, the anchored body confining pressure pull-out unit comprises a confining pressure chamber, X-direction loading hydraulic cylinders, Y-direction loading hydraulic cylinders, a rectangular reaction frame, a confining pressure pull-out specimen, and an anchor;

wherein the confining pressure chamber is movable to the upper end surface of the base via the guide rails;

a plurality of the X-direction loading hydraulic cylinders are arranged on a left side of the confining pressure chamber along a vertical direction, telescopic ends of the X-direction loading hydraulic cylinders extend and retract along an X-direction, an X-direction confining pressure loading plate is arranged at the telescopic end of each of the X-direction loading hydraulic cylinders, and a space is left between the X-direction confining pressure loading plate and a right inner wall of the confining pressure chamber;

a plurality of the Y-direction loading hydraulic cylinders are arranged on a front side of the confining pressure chamber along a vertical direction, telescopic ends of the Y-direction loading hydraulic cylinders extend and retract along a Y-direction, a Y-direction confining pressure loading plate is arranged at the telescopic end of each of the Y-direction loading hydraulic cylinders, and a space is left between the Y-direction confining pressure loading plate and a rear inner wall of the confining pressure chamber;

a specimen filling port is formed at an upper end of the confining pressure chamber, and the rectangular reaction frame is assembled on the specimen filling port;

the X-direction confining pressure loading plate, the right inner wall of the confining pressure chamber, the Y-direction confining pressure loading plate, the rear inner wall of the confining pressure chamber, a lower end surface inner wall of the confining pressure chamber, and the rectangular reaction frame collectively define a confining pressure pull-out specimen space;

the confining pressure pull-out specimen is disposed in the confining pressure pull-out specimen space, one end of the anchor is anchored and connected inside the confining pressure pull-out specimen, the other end of the anchor passes through the rectangular reaction frame, and the other end of the anchor is connected to the loading head.

Further, the anchored body double-shear unit comprises a shear baseplate, a left specimen chamber, a right specimen chamber, tie rods, a shear specimen, and an anchor;

wherein the shear baseplate is movable to the upper end surface of the base via the guide rails;

the left specimen chamber is arranged at a left end of the shear baseplate, the right specimen chamber is arranged at a right end of the shear baseplate, a space is left between the left specimen chamber and the right specimen chamber, and the left specimen chamber and the right specimen chamber are connected by a plurality of the tie rods;

both ends of the shear specimen are located in the left specimen chamber and the right specimen chamber respectively, the anchor passes through the shear specimen and is anchored and connected to the shear specimen, and both ends of the anchor are connected to the left specimen chamber and the right specimen chamber respectively;

the loading head acts on a middle position of the shear specimen.

Further, the anchored body double-shear unit further comprises spoke-type force sensors arranged at both ends of the anchor.

Further, the surface protection structure performance testing unit comprises a support frame, lateral confining pressure plates, a normal reaction plate, a normal loading airbag, an anchor mesh, a surface protection structure pull-out specimen, and an anchor;

wherein an anchor mesh anchoring port is arranged at a middle position of a lower end of the support frame, a plurality of the lateral confining pressure plates are arranged at an edge position of the support frame, and the normal reaction plate is arranged at upper ends of the lateral confining pressure plates;

the normal loading airbag is arranged on the normal reaction plate at a position corresponding to the anchor mesh anchoring port.

the anchor mesh is assembled at the position of the anchor mesh anchoring port at the lower end of the support frame;

the lateral confining pressure plates, the normal loading airbag, and the anchor mesh collectively enclose to form a surface protection structure pull-out specimen space.

the surface protection structure pull-out specimen is placed in the surface protection structure pull-out specimen space, the anchor passes through the surface protection structure pull-out specimen and is anchored and connected to the surface protection structure pull-out specimen, a lower end of the anchor is connected to the anchor mesh via an anchoring assembly, an upper end of the anchor passes through the normal loading airbag and the normal reaction plate, and the upper end of the anchor is connected to the loading head.

Further, the test platform further comprises a moving unit comprising a support body, lifting columns, guide rail wheels, and lifting support portions;

wherein the support body is respectively arranged on the anchored body confining pressure pull-out unit, the anchored body double-shear unit, and the surface protection structure performance testing unit;

a plurality of the lifting columns are arranged at edge positions of the support body, the lifting columns can move and lock relative to the support body along a longitudinal direction, lower ends of the lifting columns are rotatably connected to the guide rail wheels, and the guide rail wheels are in rolling contact with the guide rails;

a plurality of the lifting support portions are arranged at the edge positions of the support body, and the lifting support portions are used in conjunction with a jack so that the support body is driven to be raised and lowered by the jack.

Provided is a test method for an anchorage support system in deep rock mass engineering applying the aforementioned test platform for an anchorage support system in deep rock mass engineering, the method enabling selective execution of a confining pressure pull-out test, a double shear test, and a surface protection structure performance test:

### a. confining pressure pull-out test

### step a1. specimen installation

filling the confining pressure pull-out specimen into the confining pressure pull-out specimen space of the anchored body confining pressure pull-out unit, anchoring and connecting one end of the anchor inside the confining pressure pull-out specimen via an anchoring agent, passing the other end of the anchor through the rectangular reaction frame, moving the confining pressure chamber to the upper end surface of the base via the guide rails, and connecting the other end of the anchor to the loading head of the loading host via the anchoring assembly;

### step a2. confining pressure loading

applying pressure by the x-direction loading hydraulic cylinders and the y-direction loading hydraulic cylinders to the confining pressure pull-out specimen in the x-axis and y-axis directions respectively; wherein the pressures applied to the confining pressure pull-out specimen by the x-direction loading hydraulic cylinders along the vertical direction are the same or different, and the pressures applied to the confining pressure pull-out specimen by the y-direction loading hydraulic cylinders along the vertical direction are the same or different;

### step a3. confining pressure pull-out loading

according to a pull-out speed and a pull-out stroke set by the test, pulling the anchor upward by the loading head of the loading host, collecting load data in real time by the pressure sensor, and collecting displacement data in real time by the displacement sensor, thereby obtaining time-load curves, time-displacement curves, and displacement-load curves;

### b. double shear test

### step b1. specimen installation

placing both ends of the shear specimen in the left specimen chamber and the right specimen chamber of the anchored body double-shear unit respectively, passing the anchor through the shear specimen and anchoring and connecting the anchor to the shear specimen via an anchoring agent, connecting both ends of the anchor to the left specimen chamber and the right specimen chamber via the anchoring assembly respectively, moving the shear baseplate to the upper end surface of the base via the guide rails, and acting the loading head of the loading host on the middle position of the shear specimen;

### step b2. shear loading

according to a shear speed and a shear stroke set by the test, loading the shear specimen downward by the loading head of the loading host, collecting shear load data in real time by the pressure sensor, collecting shear displacement data in real time by the displacement sensor, and collecting anchor tensile force data in real time by the spoke-type force sensors;

### c. surface protection structure performance test

### step c1. specimen installation

filling the surface protection structure pull-out specimen into the surface protection structure pull-out specimen space of the surface protection structure performance testing unit, passing the anchor through the surface protection structure pull-out specimen and anchoring and connecting the anchor to the surface protection structure pull-out specimen via an anchoring agent, connecting the lower end of the anchor to the anchor mesh via the anchoring assembly, passing the upper end of the anchor through the normal loading airbag and the normal reaction plate, injecting gas at a set pressure into the normal loading airbag to make the normal loading airbag fit the surface protection structure pull-out specimen, moving the support frame to the upper end surface of the base via the guide rails, and connecting the upper end of the anchor to the loading head;

### step c2. support component pull-out loading

according to a pull-out speed and a pull-out stroke set by the test, pulling the anchor upward by the loading head of the loading host, collecting load data in real time by the pressure sensor to reach an anchor pre-tightening force, continuing to inflate the normal loading airbag with gas to make the surface protection structure pull-out specimen drive the anchor mesh to protrude downward, collecting displacement data in real time by the displacement sensor, thereby obtaining time-load curves, time-displacement curves, and displacement-load curves; simultaneously, observing failure conditions of the anchor mesh, the surface protection structure pull-out specimen, and the anchor.

The beneficial technical effects of the present invention are as follows:

The present invention can conveniently perform confining pressure pull-out tests, double shear tests, and surface protection structure performance tests through a single test platform, and can realistically simulate the stress conditions of the anchorage support system, conduct accurate mechanical tests on the anchorage support system, test the bearing capacity of the anchorage support system, and reveal the corresponding action mechanisms of the anchorage support system, so that relevant test results can provide key theoretical and technical support for the safe construction of deep rock mass engineering and the efficient and safe exploitation of deep underground resources.

### BRIEF DESCRIPTION OF THE DRAWINGS

FIG. 1 is a schematic layout diagram of a test platform for an anchorage support system in deep rock mass engineering according to an embodiment of the present invention;

FIG. 2 is a schematic layout diagram of a body portion of the test platform for an anchorage support system in deep rock mass engineering according to an embodiment of the present invention;

FIG. 3 is a schematic layout diagram of performing a confining pressure pull-out test by the test platform for an anchorage support system in deep rock mass engineering according to an embodiment of the present invention;

FIG. 4 is a schematic layout diagram of performing a double shear test by the test platform for an anchorage support system in deep rock mass engineering according to an embodiment of the present invention;

FIG. 5 is a schematic layout diagram of performing a surface protection structure performance test by the test platform for an anchorage support system in deep rock mass engineering according to an embodiment of the present invention;

FIG. 6 is a perspective view of a loading host according to an embodiment of the present invention;

FIG. 7 is a front view of the loading host according to an embodiment of the present invention;

FIG. 8 is a side view of the loading host according to an embodiment of the present invention;

FIG. 9 is a perspective view of an anchored body confining pressure pull-out unit according to an embodiment of the present invention;

FIG. 10 is a front view of the anchored body confining pressure pull-out unit according to an embodiment of the present invention;

FIG. 11 is a sectional view taken along line A-A in FIG. 10;

FIG. 12 is a top view of the anchored body confining pressure pull-out unit according to an embodiment of the present invention;

FIG. 13 is a partial perspective view of the anchored body confining pressure pull-out unit according to an embodiment of the present invention;

FIG. 14 is a perspective view of an anchored body double-shear unit according to an embodiment of the present invention;

FIG. 15 is a top view of the anchored body double-shear unit according to an embodiment of the present invention

FIG. 16 is a sectional view taken along line B-B in FIG. 15;

FIG. 17 is a side view of the anchored body double-shear unit according to an embodiment of the present invention;

FIG. 18 is a perspective view of a surface protection structure performance testing unit according to an embodiment of the present invention;

FIG. 19 is a front view showing the cooperation between the surface protection structure performance testing unit and the loading host according to an embodiment of the present invention;

FIG. 20 is a partial perspective view of the surface protection structure performance testing unit according to an embodiment of the present invention;

FIG. 21 is a bottom view of the surface protection structure performance testing unit according to an embodiment of the present invention;

FIG. 22 is a front view of the surface protection structure performance testing unit according to an embodiment of the present invention; and

FIG. 23 is a sectional view taken along line C-C in FIG. 22.

### DETAILED DESCRIPTION OF THE EMBODIMENTS

In order to make the technical problems, technical solutions and beneficial effects of the present invention clearer, the present invention will be further described in detail below with reference to the accompanying drawings and embodiments.

In the description of the present invention, it should be understood that if orientation or position relations indicated by the terms such as "upper," "lower," "left," "right," "front," "back," and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

In the present invention, the terms "first," "second," and "third" are merely for the purpose of description, but cannot be understood as indicating or implying relative importance. The term "multiple" means two or more unless otherwise explicitly defined. The terms "mount," "connect with," "connect," "fix," and the like shall be understood in a broad sense. For example, "connect" may mean being fixedly connected, detachably connected, or integrally connected; and "connect with" may mean being directly connected or indirectly connected through an intermediary. For those of ordinary skill in the art, specific meanings of the above terms in the present invention can be understood according to specific situations.

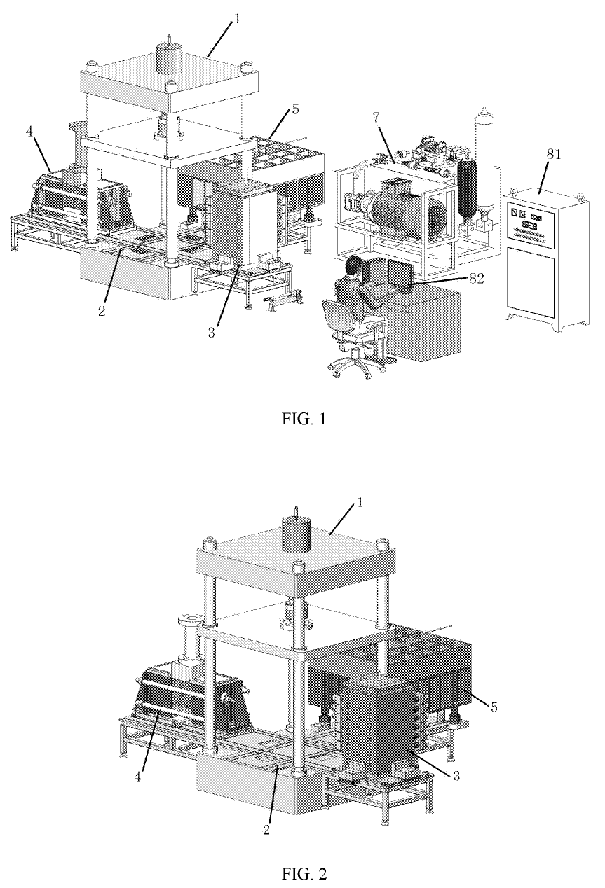

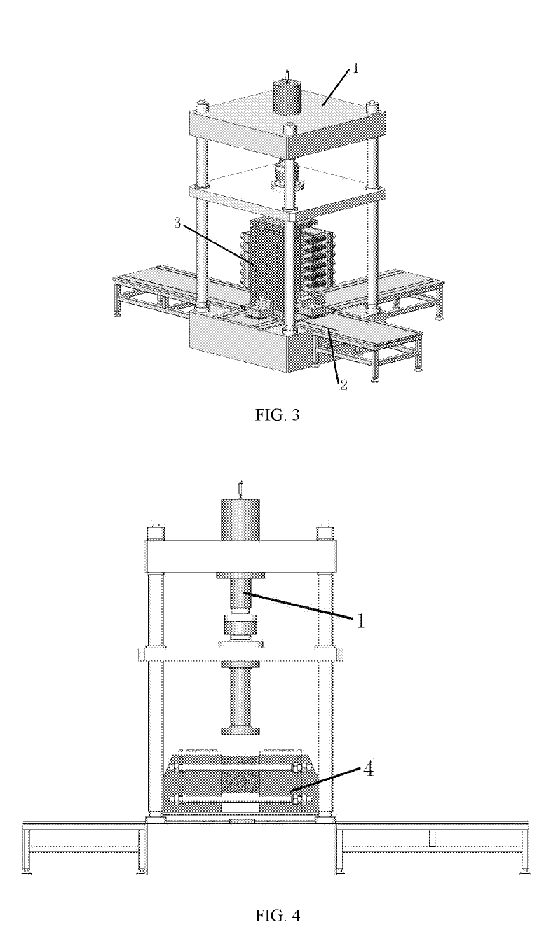

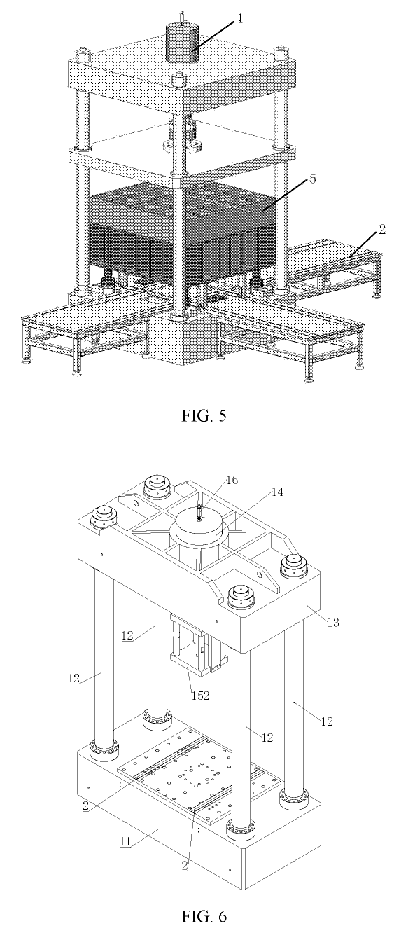

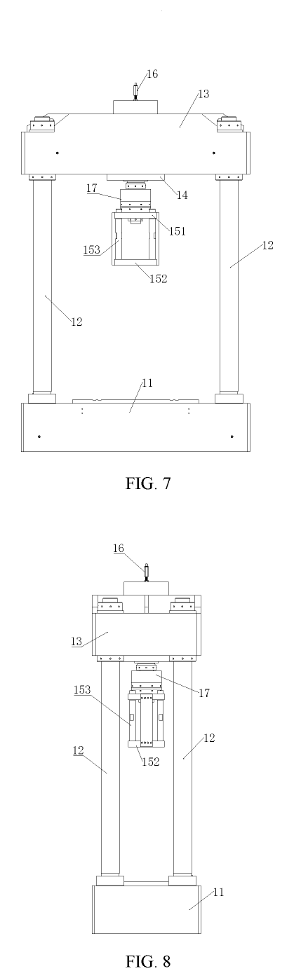

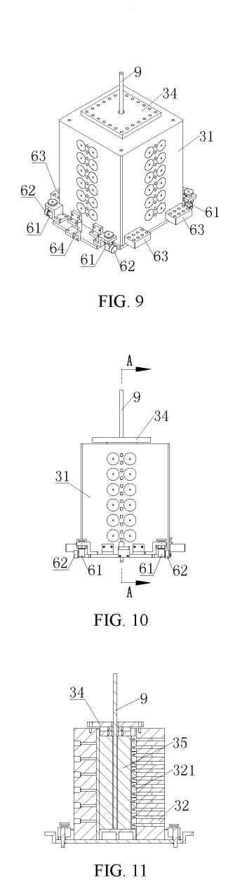

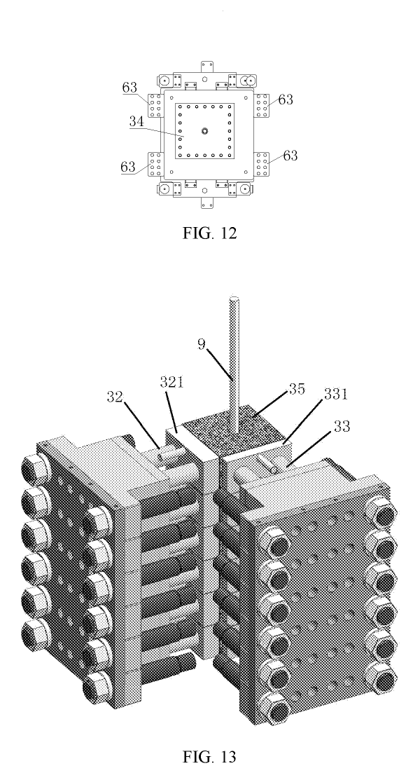

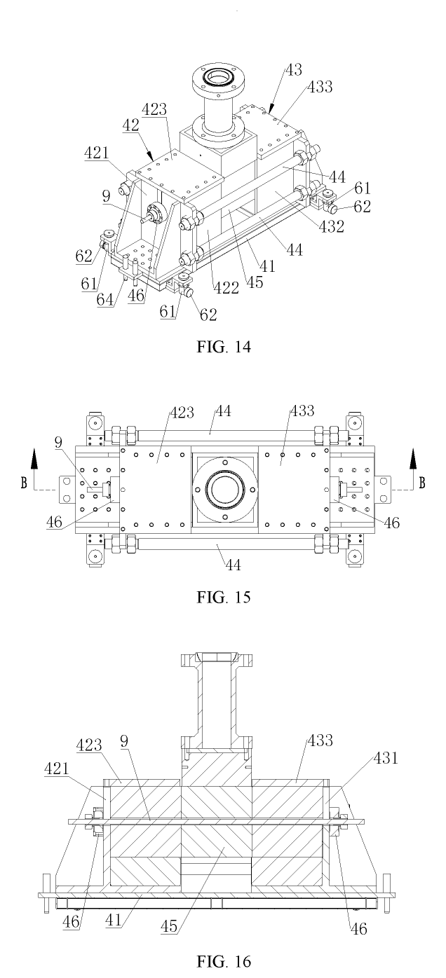

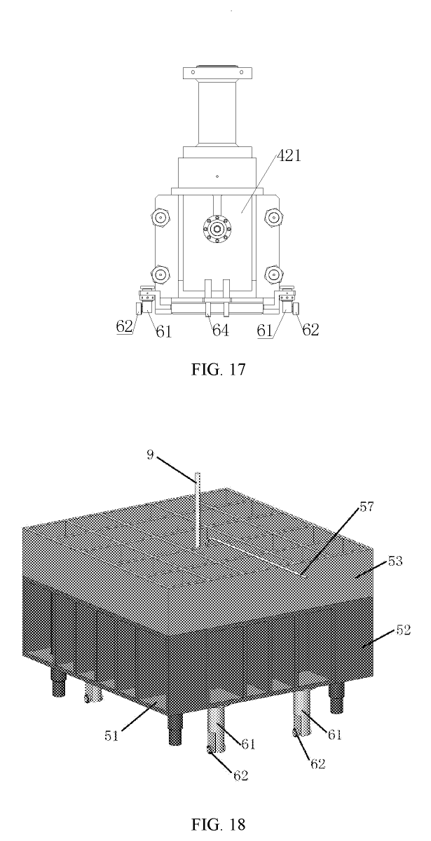

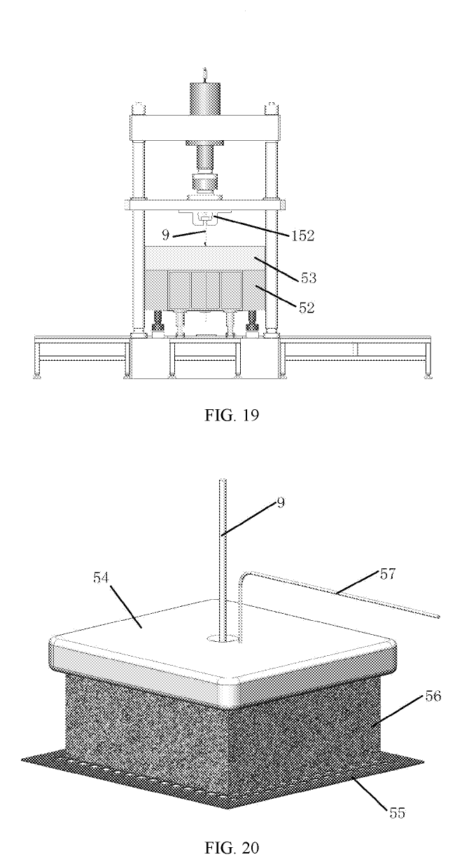

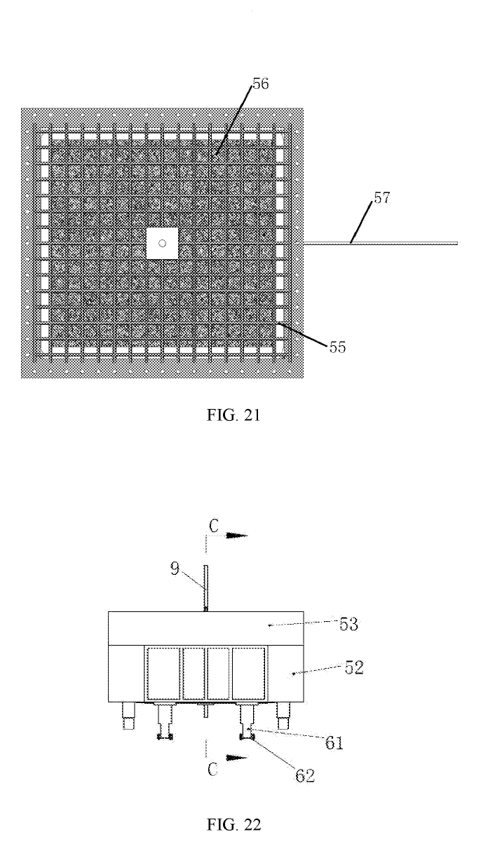

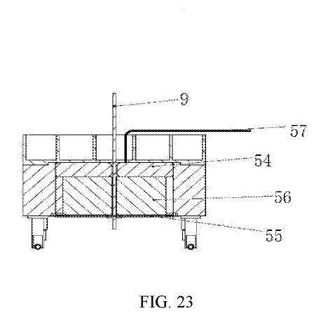

In the embodiments of the present invention, a test platform and method for an anchorage support system in deep rock mass engineering are provided, please refer to FIGS. 1 to 23.

A test platform for an anchorage support system in deep rock mass engineering includes a loading host 1, guide rails 2, an anchored body confining pressure pull-out unit 3, an anchored body double-shear unit 4, a surface protection structure performance testing unit 5, a moving unit, a hydraulic servo system 7, a control system 81, and an operating system 82.

The loading host 1 includes a base 11, columns 12, a reaction frame 13, a hollow loading hydraulic cylinder 14, and a loading head; where the guide rails 2 pass through an upper end surface of the base 11, the reaction frame 13 is located directly above the base 11, the base 11 and the reaction frame 13 are connected by four columns 12, and a cylinder body end of the hollow loading hydraulic cylinder 14 is arranged on the reaction frame 13; the hollow loading hydraulic cylinder 14 is arranged along a vertical direction, the loading head is arranged at a telescopic end of the hollow loading hydraulic cylinder 14; and the loading head selectively acts on the anchored body confining pressure pull-out unit 3, the anchored body double-shear unit 4, and the surface protection structure performance testing unit 5.

The loading head includes an upper loading seat 151, a lower loading seat 152, and a loading frame 153; wherein the upper loading seat 151 is connected to the telescopic end of the hollow loading hydraulic cylinder 14, the lower loading seat 152 is located below the upper loading seat 151, and the upper loading seat 151 and the lower loading seat 152 are connected by the loading frame 153. When the loading head moves downward to perform a loading action, the lower loading seat 152 directly acts on an object to be exerted, for example, the lower loading seat 152 directly acts on a shear specimen 45 in the anchored body double-shear unit 4. A tail end of an anchor 9 is passed through the lower loading seat 152 from below, exposed from above the lower loading seat 152, and the tail end of the anchor 9 is anchored and connected to the lower loading seat 152 via an anchoring assembly. The loading head, when moving upward to perform a loading action, can drive the anchor 9 to perform a pull-out action, for example, the lower loading seat 152 drives the anchors 9 in the anchored body confining pressure pull-out unit 3 and the surface protection structure performance testing unit 5 to perform a pull-out action.

The loading host 1 further includes a displacement sensor 16 and a pressure sensor 17, where a sensing end of the displacement sensor 16 is arranged inside the hollow loading hydraulic cylinder 14 to monitor the hydraulic oil pressure inside the hollow loading hydraulic cylinder 14; and the pressure sensor 17 is arranged between the telescopic end of the hollow loading hydraulic cylinder 14 and the loading head to monitor the pressure applied by the loading head.

Through the loading host 1 itself, a performance test of support components can be realized: one end of the anchor 9 is connected to the base 11, the other end of the anchor 9 is connected to the loading head, and a direct pull-out test is performed on the anchor 9 to test the bearing performance of the anchor 9 and anchoring components (e.g., trays, nuts, etc.); and rock blocks, concrete blocks, etc. are placed on the base 11, and loaded by the loading head.

The guide rails 2 are arranged in several groups. The guide rails 2 pass through the loading host 1 and extend toward the periphery of the loading host 1. The guide rails 2 are arranged in two groups that are vertically disposed.

The anchored body confining pressure pull-out unit 3 is arranged at one end of the first group of guide rails 2, the anchored body confining pressure pull-out unit 3 can move along the guide rails 2 to the position of the loading host 1, and the loading host 1 acts on the anchored body confining pressure pull-out unit 3 to perform a confining pressure pull-out test.

The anchored body double-shear unit 4 is arranged at the other end of the first group of guide rails 2, the anchored body double-shear unit 4 can move along the guide rails 2 to the position of the loading host 1, and the loading host 1 acts on the anchored body double-shear unit 4 to perform a double shear test.

The surface protection structure performance testing unit 5 is arranged at one end of the second group of guide rails 2, the surface protection structure performance testing unit 5 can move along the guide rails 2 to the position of the loading host 1, and the loading host 1 acts on the surface protection structure performance testing unit 5 to perform an anchor mesh pull-out test.

The anchored body confining pressure pull-out unit 3 includes a confining pressure chamber 31, X-direction loading hydraulic cylinders 32, Y-direction loading hydraulic cylinders 33, a rectangular reaction frame 34, a confining pressure pull-out specimen 35, and an anchor 9. The confining pressure chamber 31 is movable to an upper end surface of the base 11 via the guide rails 2; a plurality of the X-direction loading hydraulic cylinders 32 are arranged on a left side of the confining pressure chamber 31 along a vertical direction, telescopic ends of the X-direction loading hydraulic cylinders 32 extend and retract along an X-direction, an X-direction confining pressure loading plate 321 is arranged at the telescopic end of each of the X-direction loading hydraulic cylinders 32, and a space is left between the X-direction confining pressure loading plate 321 and a right inner wall of the confining pressure chamber 31;a plurality of the Y-direction loading hydraulic cylinders 33 are arranged on a front side of the confining pressure chamber 31 along a vertical direction, telescopic ends of the Y-direction loading hydraulic cylinders 33 extend and retract along a Y-direction, a Y-direction confining pressure loading plate 331 is arranged at the telescopic end of each of the Y-direction loading hydraulic cylinders 33, and a space is left between the Y-direction confining pressure loading plate 331 and a rear inner wall of the confining pressure chamber 31. A specimen filling port is formed at an upper end of the confining pressure chamber 31, the rectangular reaction frame 34 is assembled on the specimen filling port, the X-direction confining pressure loading plate 321, the right inner wall of the confining pressure chamber 31, the Y-direction confining pressure loading plate 331, the rear inner wall of the confining pressure chamber 31, a lower end surface inner wall of the confining pressure chamber 31, and the rectangular reaction frame 34 collectively define a confining pressure pull-out specimen space. The confining pressure pull-out specimen 35 is disposed in the confining pressure pull-out specimen space, one end of the anchor 9 is anchored and connected inside the confining pressure pull-out specimen 35, the other end of the anchor 9 passes through the rectangular reaction frame 34, and the other end of the anchor 9 is connected to the loading head.

The X-direction loading hydraulic cylinders 32 apply X-direction surrounding rock loading to the confining pressure pull-out specimen 35, and the Y-direction loading hydraulic cylinders 33 apply Y-direction surrounding rock loading to the confining pressure pull-out specimen 35. A plurality of the X-direction loading hydraulic cylinders 32 are provided along the vertical direction, and the pressures applied to the confining pressure pull-out specimen 35 by the X-direction loading hydraulic cylinders 32 along the vertical direction are the same or different; and a plurality of the Y-direction loading hydraulic cylinders 33 are provided along the vertical direction, and the pressures applied to the confining pressure pull-out specimen 35 by the Y-direction loading hydraulic cylinders 33 along the vertical direction are the same or different. When the pressures applied to the confining pressure pull-out specimen 35 by the X-direction loading hydraulic cylinders 32 are the same, and the pressures applied to the confining pressure pull-out specimen 35 by the Y-direction loading hydraulic cylinders 33 are the same, uniform loading is applied to the confining pressure pull-out specimen 35; and when the pressures applied to the confining pressure pull-out specimen 35 by the X-direction loading hydraulic cylinders 32 are different, and/or the pressures applied to the confining pressure pull-out specimen 35 by the Y-direction loading hydraulic cylinders 33 are different, non-uniform loading is applied to the confining pressure pull-out specimen 35.

The anchored body double-shear unit 4 includes a shear baseplate 41, a left specimen chamber 42, a right specimen chamber 43, tie rods 44, a shear specimen 45, and an anchor 9. The shear baseplate 41 is movable to the upper end surface of the base 11 via the guide rails 2. The left specimen chamber 42 is arranged at a left end of the shear baseplate 41, the right specimen chamber 43 is arranged at a right end of the shear baseplate 41, a space is left between the left specimen chamber 42 and the right specimen chamber 43, and the left specimen chamber 42 and the right specimen chamber 43 are connected by two tie rods 44 each at the front and rear. The left specimen chamber 42 includes a left vertical plate 421, a left front chamber plate 422, a left rear chamber plate, and a left upper cover plate 423, where the left vertical plate 421 is located at the left middle position of the shear baseplate 41, the left vertical plate 421, the left front chamber plate 422 and the left rear chamber plate extend along the vertical direction, the left front chamber plate 422 is located at a left front end of the shear baseplate 41, the left rear chamber plate is located at a left rear end of the shear baseplate 41, the left upper cover plate 423 is connected to the upper ends of the left front chamber plate 422 and the left rear chamber plate, and the right end of the left specimen chamber 42 is open. The right specimen chamber 43 includes a right vertical plate 431, a right front chamber plate 432, a right rear chamber plate, and a right upper cover plate 433, where the right vertical plate 431 is located at the right middle position of the shear baseplate 41, the right vertical plate 431, the right front chamber plate 432 and the right rear chamber plate extend along the vertical direction, the right front chamber plate 432 is located at the right front end of the shear baseplate 41, the right rear chamber plate is located at the right rear end of the shear baseplate 41, the right upper cover plate 433 is connected to the upper ends of the right front chamber plate 432 and the right rear chamber plate, and the left end of the right specimen chamber 43 is open. Both ends of the shear specimen 45 are located in the left specimen chamber 42 and the right specimen chamber 43 respectively, the anchor 9 passes through the shear specimen 45 and is anchored and connected to the shear specimen 45, and both ends of the anchor 9 are connected to the left specimen chamber 42 and the right specimen chamber 43 via the anchoring assembly respectively; and the loading head acts on a middle position of the shear specimen 45. The anchored body double-shear unit 4 further includes spoke-type force sensors 46, the spoke-type force sensors 46 are arranged at both ends of the anchor 9, and the spoke-type force sensors 46 are used for real-time acquisition of tensile force data of the anchor.

The surface protection structure performance testing unit 5 includes a support frame 51, lateral confining pressure plates 52, a normal reaction plate 53, a normal loading airbag 54, an anchor mesh 55, a surface protection structure pull-out specimen 56, and an anchor 9. An anchor mesh anchoring port is arranged at a middle position of a lower end of the support frame 51, four lateral confining pressure plates 52 are arranged at an edge position of the support frame 51, and the normal reaction plate 53 is arranged at upper ends of the lateral confining pressure plates 52. the normal loading airbag 54 is arranged on the normal reaction plate 53 at a position corresponding to the anchor mesh anchoring port, the normal loading airbag 54 communicates with an airbag loading air pipe 57, and gas at a set pressure is injected into the normal loading airbag 54 through the airbag loading air pipe 57. After the normal loading airbag 54 is inflated and expanded, the normal loading airbag 54 fits and acts on the surface protection structure pull-out specimen 56 to simulate the effect of the overlying rock strata on the immediate roof (the surface protection structure pull-out specimen 56). The anchor mesh 55 is arranged at the position of the anchor mesh anchoring port at the lower end of the support frame 51, and the lateral confining pressure plates 52, the normal loading airbag 54 and the anchor mesh 55 collectively enclose to form a surface protection structure pull-out specimen space. The surface protection structure pull-out specimen 56 is placed in the surface protection structure pull-out specimen space, the anchor 9 passes through the surface protection structure pull-out specimen 56 and is anchored and connected to the surface protection structure pull-out specimen 56, a lower end of the anchor 9 is connected to the anchor mesh 55 via an anchoring assembly, an upper end of the anchor 9 passes through the normal loading airbag 54 and the normal reaction plate 53, and the upper end of the anchor 9 is connected to the loading head.

The moving unit includes a support body, lifting columns 61, guide rail wheels 62, and lifting support portions 63. The support body is respectively arranged on the anchored body confining pressure pull-out unit 3, the anchored body double-shear unit 4, and the surface protection structure performance testing unit 5. Specifically, the support body on the anchored body confining pressure pull-out unit 3 is the confining pressure chamber 31, the support body on the anchored body double-shear unit 4 is the shear baseplate 41, and the support body on the surface protection structure performance testing unit 5 is the support frame 51. A plurality of the lifting columns 61 are arranged at edge positions of the support body, the lifting columns 61 can move and lock relative to the support body along a longitudinal direction, lower ends of the lifting columns 61 are rotatably connected to the guide rail wheels 62, and the guide rail wheels 62 are in rolling contact with the guide rails 2. A plurality of lifting support portions 63 are arranged at the edge positions of the support body, and the lifting support portions 63 are used in conjunction with a jack so that the support body is driven to be raised and lowered by the jack.

When the support body needs to be moved, first, the jack is used in conjunction with the lifting support portions 63 to raise the support body by the jack, the lifting columns 61 are moved downward relative to the support body along the longitudinal direction and locked so that the guide rail wheels 62 contact the guide rails 2, then the jack is disengaged from the lifting support portions 63, and an operator pushes the support body to make the guide rail wheels 62 move along the guide rails 2. When the support body is moved to a desired position, first, the jack is used in conjunction with the lifting support portions 63 to raise the support body by the jack, the lifting columns 61 are moved upward relative to the support body along the longitudinal direction and locked so that the guide rail wheels 62 are disengaged from the guide rails 2, then the jack is disengaged from the lifting support portions 63, and the support body is kept at the position. In addition, positioning pins 64 are also arranged at the support body. When the support body is moved to the upper end surface of the base 11, the positioning pins 64 cooperate with positioning holes on the upper end surface of the base 11 to achieve positioning of the support body, avoiding position offset of the support body during the test and affecting the test accuracy.

The hydraulic servo system 7 is configured to provide hydraulic power for the hydraulic cylinders and jacks.

The operating system 82 is connected to the control system 81 via signal cables, and the control system 81 is connected to the components such as the sensors, the hydraulic cylinders, and the hydraulic servo system 7 via signal cables. An operator operates the control system 81 through the operating system 82. The control system 81 collects and processes data in real time, and achieves action control of the components such as the hydraulic cylinders and the hydraulic servo system 7.

A test method for an anchorage support system in deep rock mass engineering applies the test platform for an anchorage support system in deep rock mass engineering described above in the present embodiment, and enables selective execution of a confining pressure pull-out test, a double shear test, and a surface protection structure performance test:

### a. Confining pressure pull-out test

### Step a1. Specimen installation

Filling the confining pressure pull-out specimen 35 into the confining pressure pull-out specimen space of the anchored body confining pressure pull-out unit 3, anchoring and connecting one end of the anchor 9 inside the confining pressure pull-out specimen 35 via an anchoring agent, passing the other end of the anchor 9 through the rectangular reaction frame 34, moving the confining pressure chamber 31 to the upper end surface of the base 11 via the guide rails 2, and connecting the other end of the anchor 9 to the loading head of the loading host 1 via the anchoring assembly;

### Step a2. Confining pressure loading

Applying pressure by the X-direction loading hydraulic cylinders 32 and the Y-direction loading hydraulic cylinders 33 to the confining pressure pull-out specimen 35 in the X-axis and Y-axis directions respectively; where the pressures applied to the confining pressure pull-out specimen 35 by the X-direction loading hydraulic cylinders 32 along the vertical direction are the same or different, and the pressures applied to the confining pressure pull-out specimen 35 by the Y-direction loading hydraulic cylinders 33 along the vertical direction are the same or different;

### Step a3. Confining pressure pull-out loading

According to a pull-out speed and a pull-out stroke set by the test, pulling the anchor 9 upward by the loading head of the loading host 1, collecting load data in real time by the pressure sensor 17, and collecting displacement data in real time by the displacement sensor 16, thereby obtaining time-load curves, time-displacement curves, and displacement-load curves;

### b. Double shear test

### Step b1. Specimen installation

Placing both ends of the shear specimen 45 in the left specimen chamber 42 and the right specimen chamber 43 of the anchored body double-shear unit 4 respectively, passing the anchor 9 through the shear specimen 45 and anchoring and connecting the anchor to the shear specimen 45 via an anchoring agent, connecting both ends of the anchor 9 to outer end surfaces of the left specimen chamber 42 and the right specimen chamber 43 via the anchoring assembly respectively, moving the shear baseplate 41 to the upper end surface of the base 11 via the guide rails 2, and acting the loading head of the loading host 1 on the middle position of the shear specimen 45;

### Step b2. Shear loading

According to a shear speed and a shear stroke set by the test, loading the shear specimen 45 by the loading head of the loading host 1, collecting shear load data in real time by the pressure sensor 17, collecting shear displacement data in real time by the displacement sensor 16, and collecting anchor tensile force data in real time by the spoke-type force sensors 46;

### c. Surface protection structure performance test

### Step c1. Specimen installation

Filling the surface protection structure pull-out specimen 56 into the surface protection structure pull-out specimen space of the surface protection structure performance testing unit 5, passing the anchor 9 through the surface protection structure pull-out specimen 56 and anchoring and connecting the anchor to the surface protection structure pull-out specimen 56 via an anchoring agent, connecting the lower end of the anchor 9 to the anchor mesh 55 via the anchoring assembly, passing the upper end of the anchor 9 through the normal loading airbag 54 and the normal reaction plate 53, injecting gas at a set pressure into the normal loading airbag 54 by an airbag loading air pipe 57 to make the normal loading airbag 54 fit the surface protection structure pull-out specimen 56, moving the support frame 51 to the upper end surface of the base 11 via the guide rails 2, and connecting the upper end of the anchor 9 to the loading head;

### Step c2. Support component pull-out loading

According to a pull-out speed and a pull-out stroke set by the test, pulling the anchor 9 upward by the loading head of the loading host 1, collecting load data in real time by the pressure sensor 17 to reach an anchor pre-tightening force, continuing to inflate the normal loading airbag 54 with gas to make the surface protection structure pull-out specimen 56 drive the anchor mesh 55 to protrude downward, simulating the effect of the overlying rock strata on the immediate roof and the anchor mesh 55, collecting displacement data in real time by the displacement sensor 16, thereby obtaining time-load curves, time-displacement curves, and displacement-load curves; simultaneously, observing failure conditions of the anchor mesh 55, the surface protection structure pull-out specimen 56, and the anchor 9.

So far, the present embodiment has been described in detail with reference to the drawings. Based on the above description, those skilled in the art should have a clear understanding of the test platform and method for an anchorage support system in deep rock mass engineering according to the present invention. The test platform and method for an anchorage support system in deep rock mass engineering according to the present invention can conveniently perform confining pressure pull-out tests, double shear tests, and surface protection structure performance tests through a single test platform, and can realistically simulate the stress conditions of the anchorage support system, conduct accurate mechanical tests on the anchorage support system, test the bearing capacity of the anchorage support system, and reveal the corresponding action mechanisms of the anchorage support system, so that relevant test results can provide key theoretical and technical support for the safe construction of deep rock mass engineering and the efficient and safe exploitation of deep underground resources.

What is claimed is:

1. A test platform for an anchorage support system in deep rock mass engineering, comprising:
a loading host;
guide rails which are arranged in several groups, pass through the loading host and extend toward the periphery of the loading host;
an anchored body confining pressure pull-out unit which is arranged on one of the groups of guide rails and can move along the guide rails to the position of the loading host, and on which the loading host acts to perform a confining pressure pull-out test;
an anchored body double-shear unit which is arranged on one of the groups of guide rails and can move along the guide rails to the position of the loading host, and on which the loading host acts to perform a double shear test; and
a surface protection structure performance testing unit which is arranged on one of the groups of guide rails and can move along the guide rails to the position of the loading host, and on which the loading host acts to perform an anchor mesh pull-out test;
wherein the loading host comprises a base, columns, a reaction frame, a hollow loading hydraulic cylinder, and a loading head; the guide rails pass through an upper end surface of the base, the base and the reaction frame are connected by a plurality of columns, the hollow loading hydraulic cylinder is arranged on the reaction frame; the hollow loading hydraulic cylinder is arranged along a vertical direction, and the loading head is arranged at a telescopic end of the hollow loading hydraulic cylinder; the loading head selectively acts on the anchored body confining pressure pull-out unit, the anchored body double-shear unit, and the surface protection structure performance testing unit;
the loading host further comprises a displacement sensor and a pressure sensor; a sensing end of the displacement sensor is arranged inside the hollow loading hydraulic cylinder to monitor the hydraulic oil pressure inside the hollow loading hydraulic cylinder; the pressure sensor is arranged between the telescopic end of the hollow loading hydraulic cylinder and the loading head to monitor the pressure applied by the loading head;
the loading head comprises an upper loading seat, a lower loading seat, and a loading frame;
the upper loading seat is connected to the telescopic end of the hollow loading hydraulic cylinder, the lower loading seat is located below the upper loading seat, and the upper loading seat and the lower loading seat are connected by the loading frame;
the anchored body confining pressure pull-out unit comprises a confining pressure chamber, X-direction loading hydraulic cylinders, Y-direction loading hydraulic cylinders, a rectangular reaction frame, a confining pressure pull-out specimen, and an anchor;
wherein the confining pressure chamber is movable to the upper end surface of the base via the guide rails;
a plurality of the X-direction loading hydraulic cylinders are arranged on a left side of the confining pressure chamber along a vertical direction, telescopic ends of the X-direction loading hydraulic cylinders extend and retract along an X-direction, an X-direction confining pressure loading plate is arranged at the telescopic end of each of the X-direction loading hydraulic cylinders, and a space is left between the X-direction confining pressure loading plate and a right inner wall of the confining pressure chamber;
a plurality of the Y-direction loading hydraulic cylinders are arranged on a front side of the confining pressure chamber along a vertical direction, telescopic ends of the Y-direction loading hydraulic cylinders extend and retract along a Y-direction, a Y-direction confining pressure loading plate is arranged at the telescopic end of each of the Y-direction loading hydraulic cylinders, and a space is left between the Y-direction confining pressure loading plate and a rear inner wall of the confining pressure chamber;
a specimen filling port is formed at an upper end of the confining pressure chamber, and the rectangular reaction frame is assembled on the specimen filling port;
the X-direction confining pressure loading plate, the right inner wall of the confining pressure chamber, the Y-direction confining pressure loading plate, the rear inner wall of the confining pressure chamber, a lower end surface inner wall of the confining pressure chamber, and the rectangular reaction frame collectively define a confining pressure pull-out specimen space;
the confining pressure pull-out specimen is disposed in the confining pressure pull-out specimen space, one end of the anchor is anchored and connected inside the confining pressure pull-out specimen, the other end of the anchor passes through the rectangular reaction frame, and the other end of the anchor is connected to the loading head;
the anchored body double-shear unit comprises a shear baseplate, a left specimen chamber, a right specimen chamber, tie rods, a shear specimen, and an anchor;
wherein the shear baseplate is movable to the upper end surface of the base via the guide rails;
the left specimen chamber is arranged at a left end of the shear baseplate, the right specimen chamber is arranged at a right end of the shear baseplate, a space is left between the left specimen chamber and the right specimen chamber, and the left specimen chamber and the right specimen chamber are connected by a plurality of the tie rods;
both ends of the shear specimen are located in the left specimen chamber and the right specimen chamber respectively, the anchor passes through the shear specimen and is anchored and connected to the shear specimen, and both ends of the anchor are connected to the left specimen chamber and the right specimen chamber respectively;
the loading head acts on a middle position of the shear specimen;
the surface protection structure performance testing unit comprises a support frame, lateral confining pressure plates, a normal reaction plate, a normal loading airbag, an anchor mesh, a surface protection structure pull-out specimen, and an anchor;
wherein an anchor mesh anchoring port is arranged at a middle position of a lower end of the support frame, a plurality of the lateral confining pressure plates are arranged at an edge position of the support frame, and the normal reaction plate is arranged at upper ends of the lateral confining pressure plates;
the normal loading airbag is arranged on the normal reaction plate at a position corresponding to the anchor mesh anchoring port.
the anchor mesh is assembled at the position of the anchor mesh anchoring port at the lower end of the support frame;
the lateral confining pressure plates, the normal loading airbag, and the anchor mesh collectively enclose to form a surface protection structure pull-out specimen space.
the surface protection structure pull-out specimen is placed in the surface protection structure pull-out specimen space, the anchor passes through the surface protection structure pull-out specimen and is anchored and connected to the surface protection structure pull-out specimen, a lower end of the anchor is connected to the anchor mesh via an anchoring assembly, an upper end of the anchor passes through the normal loading airbag and the normal reaction plate, and the upper end of the anchor is connected to the loading head.

2. The test platform for an anchorage support system in deep rock mass engineering according to claim 1, wherein the anchored body double-shear unit further comprises spoke-type force sensors arranged at both ends of the anchor.

3. The test platform for an anchorage support system in deep rock mass engineering according to claim 1,
further comprising a moving unit comprising a support body, lifting columns, guide rail wheels, and lifting support portions;
wherein the support body is respectively arranged on the anchored body confining pressure pull-out unit, the anchored body double-shear unit, and the surface protection structure performance testing unit;
a plurality of the lifting columns are arranged at edge positions of the support body, the lifting columns can move and lock relative to the support body along a longitudinal direction, lower ends of the lifting columns are rotatably connected to the guide rail wheels, and the guide rail wheels are in rolling contact with the guide rails;
a plurality of the lifting support portions are arranged at the edge positions of the support body, and the lifting support portions are used in conjunction with a jack so that the support body is driven to be raised and lowered by the jack.

4. A test method for an anchorage support system in deep rock mass engineering, applying the test platform for an anchorage support system in deep rock mass engineering according to claim 1, and enabling selective execution of a confining pressure pull-out test, a double shear test, and a surface protection structure performance test:
a, confining pressure pull-out test
step a1, specimen installation
filling the confining pressure pull-out specimen into the confining pressure pull-out specimen space of the anchored body confining pressure pull-out unit, anchoring and connecting one end of the anchor inside the confining pressure pull-out specimen via an anchoring agent, passing the other end of the anchor through the rectangular reaction frame, moving the confining pressure chamber to the upper end surface of the base via the guide rails, and connecting the other end of the anchor to the loading head of the loading host via the anchoring assembly;
step a2, confining pressure loading
applying pressure by the x-direction loading hydraulic cylinders and the y-direction loading hydraulic cylinders to the confining pressure pull-out specimen in the x-axis and y-axis directions respectively; wherein the pressures applied to the confining pressure pull-out specimen by the x-direction loading hydraulic cylinders along the vertical direction are the same or different, and the pressures applied to the confining pressure pull-out specimen by the y-direction loading hydraulic cylinders along the vertical direction are the same or different;
step a3, confining pressure pull-out loading
according to a pull-out speed and a pull-out stroke set by the test, pulling the anchor upward by the loading head of the loading host, collecting load data in real time by the pressure sensor, and collecting displacement data in real time by the displacement sensor, thereby obtaining time-load curves, time-displacement curves, and displacement-load curves;
b, double shear test
step b1, specimen installation
placing both ends of the shear specimen in the left specimen chamber and the right specimen chamber of the anchored body double-shear unit respectively, passing the anchor through the shear specimen and anchoring and connecting the anchor to the shear specimen via an anchoring agent, connecting both ends of the anchor to the left specimen chamber and the right specimen chamber via the anchoring assembly respectively, moving the shear baseplate to the upper end surface of the base via the guide rails, and acting the loading head of the loading host on the middle position of the shear specimen;
step b2, shear loading
according to a shear speed and a shear stroke set by the test, loading the shear specimen downward by the loading head of the loading host, collecting shear load data in real time by the pressure sensor, collecting shear displacement data in real time by the displacement sensor, and collecting anchor tensile force data in real time by the spoke-type force sensors;
c, surface protection structure performance test
step c1, specimen installation
filling the surface protection structure pull-out specimen into the surface protection structure pull-out specimen space of the surface protection structure performance testing unit, passing the anchor through the surface protection structure pull-out specimen and anchoring and connecting the anchor to the surface protection structure pull-out specimen via an anchoring agent, connecting the lower end of the anchor to the anchor mesh via the anchoring assembly, passing the upper end of the anchor through the normal loading airbag and the normal reaction plate, injecting gas at a set pressure into the normal loading airbag to make the normal loading airbag fit the surface protection structure pull-out specimen, moving the support frame to the upper end surface of the base via the guide rails, and connecting the upper end of the anchor to the loading head;
step c2, support component pull-out loading
according to a pull-out speed and a pull-out stroke set by the test, pulling the anchor upward by the loading head of the loading host, collecting load data in real time by the pressure sensor to reach an anchor pre-tightening force, continuing to inflate the normal loading airbag with gas to make the surface protection structure pull-out specimen drive the anchor mesh to protrude downward, collecting displacement data in real time by the displacement sensor, thereby obtaining time-load curves, time-displacement curves, and displacement-load curves; simultaneously, observing failure conditions of the anchor mesh, the surface protection structure pull-out specimen, and the anchor.
